(19) United States
(12) Patent Application Publication
(10) Pub. No.: US 2021/0161109 A1
(43) Pub. Date: Jun. 3, 2021

(54) METHOD FOR PROTECTING ECOLOGY OF COASTAL MUDFLAT AND SYSTEM USED IN THE METHOD

(71) Applicant: Jiangsu Academy of Agricultural Sciences, Nanjing City (CN)

(72) Inventors: Shiqun Han, Nanjing City (CN); Shaohua Yan, Nanjing City (CN); Qing Zhou, Nanjing City (CN); Wenjie Xu, Nanjing City (CN); Guofeng Li, Nanjing City (CN)

(21) Appl. No.: 17/036,553

(22) Filed: Sep. 29, 2020

(30) Foreign Application Priority Data
Nov. 29, 2019 (CN) 2019111979456

(51) Int. Cl. A01K 61/73; A01B 79/02; E02B 3/10

(52) U.S. Cl. CPC A01K 61/73; E02B 3/10; A01B 79/02

(57) ABSTRACT

The present invention relates to a method for protecting the ecology of a coastal mudflat and a system used in the method. The method includes the following steps: plan and design a pond project according to the specific conditions of the target coastal mudflat to be protected; dig a trench and build a dike in the surface of the target coastal mudflat and enclose the dike to form at least one pond, wherein the trench in the pond is adjacent to the surface of the mudflat to form the pond with a large water surface, a shallow water layer and a seasonal open waterfront; and cultivate an aquatic product in the trench, with or without an emergent aquatic plant planted in the surface of the mudflat.

### FIELD OF THE INVENTION

The present invention relates to a method for protecting the ecology of a coastal mudflat and a system used in the method, and belongs to the technical field of environmental protection.

### BACKGROUND OF THE INVENTION

A coastal mudflat refers to a special zone below a high tide line, above a low tide line, and also on the sea and land during high tides. China's existing coastal mudflat of 2.6 million hectares is important reserve land resources, which grow at a rate of 26,700 to 33,300 hectares per year. The mudflat is mainly distributed in Jiangsu Province, Liaoning Province, Shandong Province and Zhejiang Province.

The coastal mudflat has been developed and utilized as economic resources for a long time. However, since we only focus on the pursuit of economic benefits, it is easy to lead to the destruction of the ecological environment of the coastal mudflat, and it is difficult to form a sustainable scientific development and utilization. At present, the idea of the development and utilization of the coastal mudflat has gradually changed to focus on the protection of the ecological environment thereof and seek the economic development based on the above. Therefore, it is urgent to develop a system for protecting the ecology of the coastal mudflat, which can achieve higher economic benefits on the basis of protecting the ecological environment.

To achieve economic benefits, it is necessary to improve the land of the coastal mudflat. The land of the coastal mudflat is characterized by high soil salinity, low soil nutrients, and being lack of organic matter. The traditional improvement method is to newly enclose the coastal mudflat to draw freshwater and salt to lightly salinized soil and then plant crops. Although this method works well, there are large investment, a long cycle, and low economic benefits and it is also likely to cause damage to the ecological environment.

The inventors of the present invention published a journal article “Influence of Different Breeding Modes on the Effects of Fish Farming and Soil Improvement in Coastal Mudflat” in 2012, which described the research results of improving soil by breeding freshwater fish in the coastal mudflat. Afterwards, the inventor of the present invention conducted further research in the field of ecological protection of the coastal mudflat to obtain corresponding research results to apply for invention patents.

### SUMMARY OF THE INVENTION

The main objective of the present invention is to overcome the problems existing in the prior art and provide a method for protecting the ecology of a coastal mudflat, which can not only play an ecological protection role but also achieve higher economic benefits. At the same time, the system used in this method is also provided.

The technical solution for solving the above technical problem of the present invention is as follows:

A method for protecting the ecology of a coastal mudflat comprises the following steps:

Step 1: plan and design a pond project according to the specific conditions of the target coastal mudflat to be protected.

Step 2: dig a trench and build a dike in the surface of the target coastal mudflat, and enclose the dike to form at least one pond, wherein the trench in the pond is adjacent to the surface of the mudflat. The depth of the trench is 2-2.5 m and the height of the dike is 0.8-1.6 m to form the pond with a large water surface, a shallow water layer and a seasonal open waterfront. The large water surface indicates that the water surface area of the single pond is at least 100 mu when the surface of the mudflat is stored with water. The shallow water layer indicates that the storage depth of water is at least 0.8 m and at most does not exceed the height of the dike when the surface of the mudflat is stored with water. The seasonal open waterfront indicates that the surface of the mudflat is kept free of water for a predetermined period of time to expose the surface of the mudflat. In addition, a drainage trough and a water supplementary ditch that are independent with each other are dug in the surface of the mudflat outside the pond. A water supplementary sluice gate and a drainage sluice gate are built in the dike so that the water supplementary ditch is connected to the pond via the water supplementary sluice gate, and the pond is connected to the drainage trough via the drainage sluice gate. When water is needed, the water supplementary sluice gate is opened and freshwater is filled into the pond via the water supplementary ditch. When drainage is needed, the drainage sluice gate is opened to drain out water via the drainage trough.

Step 3: cultivate an aquatic product in the trench, wherein the aquatic product is a fish or the fish and a shrimp, with or without an emergent aquatic plant planted in the surface of the mudflat; determine the storage progress of the water in the pond by combining the growth regularity of the emergent aquatic plant when the emergent aquatic plant is planted in the surface of the mudflat, and in accordance with the production rule of the aquatic plant cultivated in the trench so that the pond has the following specific states:

Within a first preset period of time, the pond is drained so that there is no water storage in the surface of the mudflat and the water storage is kept in the trench. An aquatic seedling is put into the trench and the dropping seedling state of the aquaculture is kept. The first preset period of time belongs to the period from October of the current year to May of the following year;

Within the second preset period of time, the pond is stored with water to fill the trench to full with water, and the surface of the mudflat is gradually stored with water. The highest water level at most flushes with the top of the dike. The floodplain state of the aquaculture continues to be kept. The second preset period of time belongs to the period from May to November in the same year;

Within a third preset period of time, the pond is drained so that there is no water storage in the surface of the mudflat and the water storage is kept in the trench. The harvesting conditions of the aquatic product is kept in the pond. The third preset period of time belongs to the period from October to December in the same year;

The dropping seedling state, the floodplain state, and the harvesting state of the aquatic product are successively connected and form a cycle;

When the emergent aquatic plant is planted in the surface of the mudflat, the pond also has the following specific states:

The sowing state of the emergent aquatic plant that is sowed in the surface of the mudflat, within a fourth preset period of time;

The crop harvesting state of the emergent aquatic plant that is reaped, within a fifth preset period of time;

The first preset period of time, the second preset period of time, and the third preset period of time are independent of each other and are not overlapped with each other. The fourth preset period of time and the fifth preset period of time are independent of each other and are not overlapped with each other. The fourth preset period of time and the fifth preset period of time are partially overlapped with or are not overlapped with the first preset period of time, the second preset period of time or the third preset period of time, respectively;

Step 4: in the process of performing Step 3, with the gradual decrease in the salinity of the soil of the coastal mudflat, adjust the structure of the pond according to the salinity of the soil of the coastal mudflat, and then continue to perform Step 3 to make the salinity of the soil of the coastal mudflat continue to fall.

It should be noted that although the first preset period of time, the second preset period of time, and third preset period of time are partially overlapped, this does not affect that the first preset period of time, the second preset period of time, and the third preset period of time are independent with each other and are not overlapped with each other. For example, if the first preset period of time is selected to be finished at the first half of May, the second preset period of time can only be selected to start as early as the second half of May. Further, if the first preset period of time is selected to start from the second half of October, the third preset period of time can only be selected to be finished at the first half of October at the latest.

The above technical solution integrates brackish water aquaculture with wetland function enhancement, can achieve economic and ecological benefits at the current year, and breaks through the limitation of traditional salt washing that can only be used after several years. According to terrain and production requirements, the area of the pond can reach several hundred acres or even ten thousand acres, thus breaking through the traditional scale of tens of acres.

In Step 3, the first preset period of time for putting an aquatic seedling is basically in late autumn, winter or spring when water temperature is low. The aquatic seedling is small, grows slowly, and is only bred in the trench. At the same time, there is no water storage in the surface of the mudflat, which allows the emergent aquatic plant to germinate and grow in spring. The second preset period of time is basically in summer and autumn, and the aquatic product in the trench and the emergent aquatic plant in the surface of the mudflat have gradually grown up. At this time, the water level can be gradually increased so that the surface of the mudflat is gradually stored with water, thereby expanding the space for the activities of the aquatic product and controlling the growth of the emergent aquatic plant. The third preset period of time is basically in late autumn or winter. After drainage, the aquatic product can be captured to produce economic benefits. The surface of the mudflat is exposed at the same time and can become a good foraging and habitat for an overwintering migratory bird. At the same time, the growth regularity of the emergent aquatic plant is combined. Sowing and harvesting are performed timely so as to obtain crop economic benefits. In this way, the aquatic product can be gradually cultivated and the emergent aquatic plant can be grown according to the seasonal changes, which can not only achieve the purpose of ecological protection, but also perform gradually desalination of the soil of the coastal mudflat and fertilization, while achieving economic benefits.

After adopting this method, seasonal changes can be combined. a water supplementary ditch and a drainage trough can be used to control water level and the salinity of the water body in the ponds. The aquatic product can be cultivated in the trench, and the emergent aquatic plant can be grown within a controlled range on the surface of the mudflat. Therefore, on the one hand, plant diversity and algae diversity of the coastal mudflat can be significantly increased, and provide a good habitat for the bird, so that the bird species and the number of the overwintering migratory birds can be significantly increased, so as to achieve a good ecological protection purpose. On the other hand, It can gradually reduce and fertilize the salinity of the soil of the coastal mudflat is gradually decreased at the fastest speed fertilization is performed, thus eventually improving the soil state. At the same time, higher economic benefits can be achieved in the process. Therefore, barriers such as high salinity, low organic matters and low nutrition of the soil of the coastal mudflat is successfully overcome, which is conducive to the large-scale promotion and application of the overall technical solution.

The method of the present invention has the following improved technical solution:

Preferably, when planning and designing the pond project in Step 1 and adjusting the structure of the pond in Step 4, decision is made according to the salinity of the soil of the target coastal mudflat, the decision comprises:

When the salinity of the soil of the target coastal mudflat is larger than 6.0 g/kg, set the total area of the trench in the pond and the surface of the mudflat be larger than 1000 mu, set the ratio of the area of the trench to the area of the surface of the mudflat be 1:0.1-100, and set that there is only aquaculture in Step 3, or the aquaculture is performed while the emergent aquatic plant is planted in the surface of the mudflat;

When the salinity of the soil of the target coastal mudflat is larger than 4.0 g/kg but equal to or less than 6.0 g/kg, set the total area of the trench in the pond and the surface of the mudflat be less than 1000 mu by building a dike bank in the pond, set the ratio of the area of the trench to the area of the surface of the mudflat be 1:0.1-100, and set that in Step 3, aquaculture is performed while the emergent aquatic plant is also planted in the surface of the mudflat;

When the salinity of the soil of the target coastal mudflat is larger than 2.0 g/kg but equal to or less than 4.0 g/kg, set the total area of the trench in the pond and the surface of the mudflat be less than 100 mu by building the dike bank in the pond, set the ratio of the area of the trench to the area of the surface of the mudflat be 1:0.1-100, and set that in Step 3, the aquaculture is performed while the emergent aquatic plant is planted in the surface of the mudflat.

By adopting the preferred solution, when the salinity of the soil of the target coastal mudflat is in a different value range, corresponding treatment decisions are adopted to better implement ecological protection for the target coastal mudflat.

More preferably, when the salinity of the soil of the target coastal mudflat is larger than 6.0 g/kg, the soil of the coastal mudflat belongs to coastal saline soil. When the salinity of the soil of the target coastal mudflat is larger than 4.0 g/kg but equal to or less than 6.0 g/kg, the soil of the coastal mudflat belongs to strongly salinized soil. When the salinity of the soil of the target coastal mudflat is larger than 2.0 g/kg but equal to or less than 4.0 g/kg, the soil of the coastal mudflat belongs to moderately salinized soil.

By adopting this preferred solution, the specific soil state can be further clarified.

Preferably, in Step 3, when the aquaculture is performed while the emergent aquatic plant is planted in the surface of the mudflat, a preset fish-agriculture mode is adopted. The fish-agriculture mode comprises planting and breeding combination modes of fish-rice rotation or relay intercropping, fish-grass rotation or relay intercropping, fish-wheat rotation or relay intercropping, fish-oilseed rape rotation or relay intercropping, fish-salt-tolerant plant rotation or relay intercropping.

With this preferred solution, when the aquaculture is performed while the emergent aquatic plant is cultivated at the same time, an appropriate fish-agriculture mode can be adopted. The nutrient brackish water in the trench is used as the irrigation water of the plant, and is circulated after be purified by the plant, and then the aquaculture is performed. The tail water of the trench can provide irrigation water and nutrients for the plant, and the crops can purify the breeding tail water and reduce the emission of pollutants. In this way, the coastal mudflat can be turned into the high-yield fish pond and high-yield farmland, which can not only protect the ecological environment but also produce higher economic benefits, so as to better overcome the obstacles such as high salinity, low organic matter and low nutrition in the coastal mudflat. In addition, the efficiency indexes of all aspects of the fish-agriculture mode are significantly higher than those of the single breeding mode.

More preferably, in the planting and breeding combination mode of the fish-wheat rotation, the ratio of the area of the trench to the planting area of barley is 1:1-20. The first preset period of time is the period from October of the current year to May of the following year when wheat is harvested. The second preset period of time is the period from May of the following year when the wheat is harvested to October. The third preset period of time is the period from October in the following year to the next first preset period of time. The fourth preset period of time is October of the current year, and the fifth preset period of time is May of the following year;

The specific processes of the fish-wheat rotation are as follows: in October of the current year, the aquatic seedling is put into the trench while the barley is sown in the surface of the mudflat without tillage. The aquatic seedling is filter-feeding fish species and eating fish species that are composed of in a predetermined proportion, after which the aquatic product is cultivated and the barley grows at the same time. After May of the following year when the wheat is harvested, water is stored to flood the mudflat by more than 1 m. The aquatic product is harvested by drainage in October of the following year, and then the next round of fish-wheat rotation starts;

In the planting and breeding combination mode of the fish-rice relay intercropping, the ratio of the area of the trench to the planting area of rice is 1:0.1-10. The first preset period of time is the period from November of the previous year to May of the current year when the rice is transplanted or the period from the beginning of May of the current year to May of the current year when the rice is transplanted. The second preset period of time is the period from May of the current year when the rice is transplanted to the time when the rice is harvested. The third preset period of time is the period from the time when the rice is harvested in the current year to the next first preset period of time. The fourth preset period of time is May of the current year, and the fifth preset period of time is the period when the rice is ripe in the current year;

The specific processes of the fish-rice relay intercropping are as follows: in November of the previous year or in May of the current year, the aquatic seedling is put into the trench and the aquatic product is cultivated. Afterwards, the rice is transplanted in the surface of the mudflat in May of current year. Afterwards, water is stored to flood the mudflat. The rice is harvested when the rice is ripe in the current year. Afterwards, the pond is drained to harvest the aquatic product; then the next round of fish-rice relay intercropping starts;

The salt-tolerant plant comprises sesbania. In the planting and breeding combination mode of fish-sesbania relay intercropping, the ratio of the area of the trench to the planting area of the barley is 1:1-20. the first preset period of time is the period from october of the current year to march of the following year when the sesbania is planted. The second preset period of time is from may of the following year to the time when the sesbania is harvested. The third preset period of time is the period from the time when the sesbania is harvested in the following year to the next first preset period of time. The fourth preset period of time is march of the following year, and the fifth preset period of time is the period when the sesbania is ripe in the following year;

The specific processes of the fish-sesbania relay intercropping are as follows: in October of the current year, the aquatic seedling is put into the trench and the aquatic product is cultivated. The eating fish species accounts for more than half of the aquatic seedling. The sesbania is sown in March of the following year. Water is stored to flood the mudflat in May of the following year until the depth of water is 1 m. The sesbania is harvested when the sesbania is ripe. Then the pond is drained to harvest the aquatic product. Afterwards, the next round of fish-sesbania relay intercropping starts.

This preferred solution not only can realize ecological and environmental protection purposes, but also achieve better economic benefits.

Preferably, in Step 3, the aquatic product in the trench is the polyculture of a conventional fish and a barracuda. The polyculture of the conventional fish and an exopalaemon carinicauda, or the polyculture of the conventional fish and an acanthogobius hasta. The conventional fish comprises at least one of a black carp, a grass carp, a silver carp, a bighead carp, and an allogynogenetic crucian carp.

With this preferred solution, the fish ecological polyculture can make full use of the complementary niche of the coastal mudflat species such as the barracuda, the allogynogenetic crucian carp, the acanthogobius hasta, etc. and the conventional fish, extending a food chain, improving feed utilization, and increasing output and economic benefits.

Preferably, the ratio of the area of the trench to the area covered by the emergent aquatic plant is 1:0.1-100. The emergent aquatic plant comprises the rice, the wheat, the barley, the sesbania, Jerusalem artichoke, reed, calamus, cattail, iris wilsonii, scirpus, willow herb and rhizoma alismatis.

This preferred solution can not only play a role in better ecological protection but also better guarantee fishery production. The water surface coverage can be used as the aquaculture range.

The present invention also provide:

A system for protecting the ecology of a coastal mudflat which is built by the following steps:

Plan and design a pond project according to the specific conditions of the target coastal mudflat to be protected; dig a trench and build a dike in the surface of the target coastal mudflat, and enclose the dike to form at least one pond, wherein the trench in the pond is adjacent to the surface of the mudflat. The depth of the trench is 2-2.5 m and the height of the dike is 0.8-1.6 m to form the pond with a large water surface, a shallow water layer and a seasonal open waterfront. The large water surface indicates that the water surface area of the single pond is at least 100 mu when the surface of the mudflat is stored with water. The shallow water layer indicates that the storage depth of water is at least 0.8 m and at most does not exceed the height of the dike when the surface of the mudflat is stored with water. The seasonal open waterfront indicates that the surface of the mudflat is kept free of water for a predetermined period of time to expose the surface of the mudflat. In addition, a drainage trough and a water supplementary ditch that are independent with each other are dug in the surface of the mudflat outside the pond. A water supplementary sluice gate and a drainage sluice gate are built in the dike so that the water supplementary ditch is connected to the pond via the water supplementary sluice gate, and the pond is connected to the drainage trough via the drainage sluice gate.

The system integrates brackish water aquaculture with wetland function enhancement, and can smoothly implement the method for protecting the ecology described above, which can not only achieve the good ecological protection purpose, but also achieve high economic benefits.

The system of the present invention has the following improved technical solution:

Preferably, the pond has the following specific states:

Within a first preset period of time, the pond is drained so that there is no water storage in the surface of the mudflat and the water storage is kept in the trench. An aquatic seedling is put into the trench and the dropping seedling state of the aquaculture is kept. The first preset period of time belongs to the period from October of the current year to May of the following year;

Within a second preset period of time, the pond is stored with water to fill the trench to full with water, and the surface of the mudflat is gradually stored with water. The highest water level at most flushes with the top of the dike. The floodplain state of the aquaculture continues to be kept. The second preset period of time belongs to the period from May to November in the same year;

Within a third preset period of time, the pond is drained so that there is no water storage in the surface of the mudflat and the water storage is kept in the trench. The harvesting conditions of the aquatic product is kept in the pond. The third preset period of time belongs to the period from October to December in the same year;

The dropping seedling state, the floodplain state, and the harvesting state of the aquatic product are successively connected and form a cycle;

When the emergent aquatic plant is planted in the surface of the mudflat, the pond also has the following specific states:

The sowing state of the emergent aquatic plant that is sowed in the surface of the mudflat, within a fourth preset period of time;

The crop harvesting state of the emergent aquatic plant that is reaped, within a fifth preset period of time;

The first preset period of time, the second preset period of time, and the third preset period of time are independent of each other and are not overlapped with each other. The fourth preset period of time and the fifth preset period of time are independent of each other and are not overlapped with each other. The fourth preset period of time and the fifth preset period of time are partially overlapped with or are not overlapped with the first preset period of time, the second preset period of time or the third preset period of time, respectively.

This preferred solution can further clarify the specific states of the pond, so as to better implement the method for protecting the ecology described above.

Preferably, when the salinity of the soil of the target coastal mudflat is larger than 6.0 g/kg, the total area of the trench in the pond and the surface of the mudflat is larger than 1000 mu. The ratio of the area of the trench to the area of the surface of the mudflat is 1:0.1-100, and there is only aquaculture in the pond, or the aquaculture is performed while the emergent aquatic plant is planted in the surface of the mudflat;

When the salinity of the soil of the target coastal mudflat is larger than 4.0 g/kg but equal to or less than 6.0 g/kg, a dike bank is built in the pond so that the total area of the trench in the pond and the surface of the mudflat is less than 1000 mu. The ratio of the area of the trench to the area of the surface of the mudflat is 1:0.1-100. The aquaculture is performed in the pond while the emergent aquatic plant is also planted in the surface of the mudflat;

When the salinity of the soil of the target coastal mudflat is larger than 2.0 g/kg but equal to or less than 4.0 g/kg, the dike bank is built in the pond so that the total area of the trench in the pond and the surface of the mudflat is less than 100 mu. The ratio of the area of the trench to the area of the surface of the mudflat is 1:0.1-100. The aquaculture is performed in the pond while the emergent aquatic plant is planted in the surface of the mudflat.

This preferred solution can further clarify the internal structure of the pond in different coastal mudflats.

Compared with the prior art, the method of the present invention can not only play an ecological protection role, but also can quickly improve the soil (washes salt, increases soil nutrients and organic matters), and achieve higher economic benefits, which is of great significance in the ecological protection and utilization of the coastal mudflat.

### BRIEF DESCRIPTION OF THE DRAWINGS

FIG. 1 is a specific experimental case of Embodiment 1 of the present invention.

FIG. 2 is a diagram of specific setting examples of Embodiment 1 and Embodiment 2 of the present invention.

FIG. 3 is a graph of the result of 0-80 cm desalination rate of soil exemplified in Embodiment 1 of the present invention.

FIGS. 4 to 7 are diagrams of a specific example of Embodiment 3 of the present invention.

FIG. 8 is an exemplary diagram of Embodiment 4 of the present invention.

### DETAILED DESCRIPTION OF THE INVENTION

The present invention will be further described in detail below with reference to the accompanying drawings and in conjunction with the embodiments. But the present invention is not limited to the examples given.

### Embodiment 1

This embodiment is a method for protecting the ecology of a coastal mudflat, comprising:

Step 1: plan and design a pond project according to the specific conditions of the target coastal mudflat to be protected.

Step 2: dig a trench and build a dike in the surface of the target coastal mudflat, and enclose the dike to form at least one pond, wherein the trench in the pond is adjacent to the surface of the mudflat. The depth of the trench is 2-2.5 m and the height of the dike is 0.8-1.6 m to form the pond with a large water surface, a shallow water layer and a seasonal open waterfront. The large water surface indicates that the water surface area of the single pond is at least 100 mu when the surface of the mudflat is stored with water. The shallow water layer indicates that the storage depth of water is at least 0.8 m and at most does not exceed the height of the dike when the surface of the mudflat is stored with water. The seasonal open waterfront indicates that the surface of the mudflat is kept free of water for a predetermined period of time to expose the surface of the mudflat. In addition, a drainage trough and a water supplementary ditch that are independent with each other are dug in the surface of the mudflat outside the pond. A water supplementary sluice gate and a drainage sluice gate are built in the dike so that the water supplementary ditch is connected to the pond via the water supplementary sluice gate, and the pond is connected to the drainage trough via the drainage sluice gate. When water is needed, the water supplementary sluice gate is opened and freshwater is filled into the pond via the water supplementary ditch; when drainage is needed, the drainage sluice gate is opened to drain out water via the drainage trough.

Step 3: cultivate an aquatic product in the trench, wherein the aquatic product is a fish or the fish and a shrimp, with or without an emergent aquatic plant planted in the surface of the mudflat; determine the storage progress of the water in the pond by combining the growth regularity of the emergent aquatic plant when the emergent aquatic plant is planted in the surface of the mudflat, and in accordance with the production rule of the aquatic plant cultivated in the trench so that the pond has the following specific states.

Within a first preset period of time, the pond is drained so that there is no water storage in the surface of the mudflat and the water storage is kept in the trench. An aquatic seedling is put into the trench and the dropping seedling state of the aquaculture is kept. The first preset period of time belongs to the period from October of the current year to May of the following year.

Within the second preset period of time, the pond is stored with water to fill the trench to full with water, and the surface of the mudflat is gradually stored with water. The highest water level at most flushes with the top of the dike. The floodplain state of the aquaculture continues to be kept. The second preset period of time belongs to the period from May to November in the same year.

Within a third preset period of time, the pond is drained so that there is no water storage in the surface of the mudflat and the water storage is kept in the trench. The harvesting conditions of the aquatic product is kept in the pond. The third preset period of time belongs to the period from October to December in the same year.

The dropping seedling state, the floodplain state, and the harvesting state of the aquatic product are successively connected and form a cycle.

When the emergent aquatic plant is planted in the surface of the mudflat, the pond also has the following specific states:

The sowing state of the emergent aquatic plant that is sowed in the surface of the mudflat, within a fourth preset period of time.

The crop harvesting state of the emergent aquatic plant that is reaped, within a fifth preset period of time.

The first preset period of time, the second preset period of time, and the third preset period of time are independent of each other and are not overlapped with each other. The fourth preset period of time and the fifth preset period of time are independent of each other and are not overlapped with each other. The fourth preset period of time and the fifth preset period of time are partially overlapped with or are not overlapped with the first preset period of time, the second preset period of time or the third preset period of time, respectively.

Step 4: in the process of performing Step 3, with the gradual decrease in the salinity of the soil of the coastal mudflat, adjust the structure of the pond according to the salinity of the soil of the coastal mudflat, and then continue to perform Step 3 to make the salinity of the soil of the coastal mudflat continue to fall.

It should be noted that although the second preset period of time and the third preset period of times are partially overlapped, this does not affect that the first preset period of time, the second preset period of time, or the third preset period of times are independent of each other and are not overlapped with each other. For example, if the first preset period of time is selected to be finished at the first half of May, the second preset period of time can only be selected to start as early as the second half of May. For example, if the first preset period of time is selected to start from the second half of October, the third preset period of time can only be selected to be finished at the first half of October at the latest.

When planning and designing the pond project in Step 1, and adjusting the structure of the pond in Step 4, decision is made according to the salinity of the soil of the target coastal mudflat, the decision comprises:

When the salinity of the soil of the target coastal mudflat is larger than 6.0 g/kg, set the total area of the trench in the pond and the surface of the mudflat be larger than 1000 mu, set the ratio of the area of the trench to the area of the surface of the mudflat be 1:0.1-100, and set that there is only aquaculture in Step 3, or the aquaculture is performed while the emergent aquatic plant is planted in the surface of the mudflat.

When the salinity of the soil of the target coastal mudflat is larger than 4.0 g/kg but equal to or less than 6.0 g/kg, set the total area of the trench in the pond and the surface of the mudflat be less than 1000 mu by building a dike bank in the pond, set the ratio of the area of the trench to the area of the surface of the mudflat be 1:0.1-100, and set that in Step 3, aquaculture is performed while the emergent aquatic plant is also planted in the surface of the mudflat.

When the salinity of the soil of the target coastal mudflat is larger than 2.0 g/kg but equal to or less than 4.0 g/kg, set the total area of the trench in the pond and the surface of the mudflat be less than 100 mu by building the dike bank in the pond, set the ratio of the area of the trench to the area of the surface of the mudflat be 1:0.1-100, and set that in Step 3, the aquaculture is performed while the emergent aquatic plant is planted in the surface of the mudflat.

When the salinity of the soil of the target coastal mudflat is larger than 6.0 g/kg, the soil of the coastal mudflat belongs to coastal saline soil. When the salinity of the soil of the target coastal mudflat is larger than 4.0 g/kg but equal to or less than 6.0 g/kg, the soil of the coastal mudflat belongs to strongly salinized soil. When the salinity of the soil of the target coastal mudflat is larger than 2.0 g/kg but equal to or less than 4.0 g/kg, the soil of the coastal mudflat belongs to moderately salinized soil.

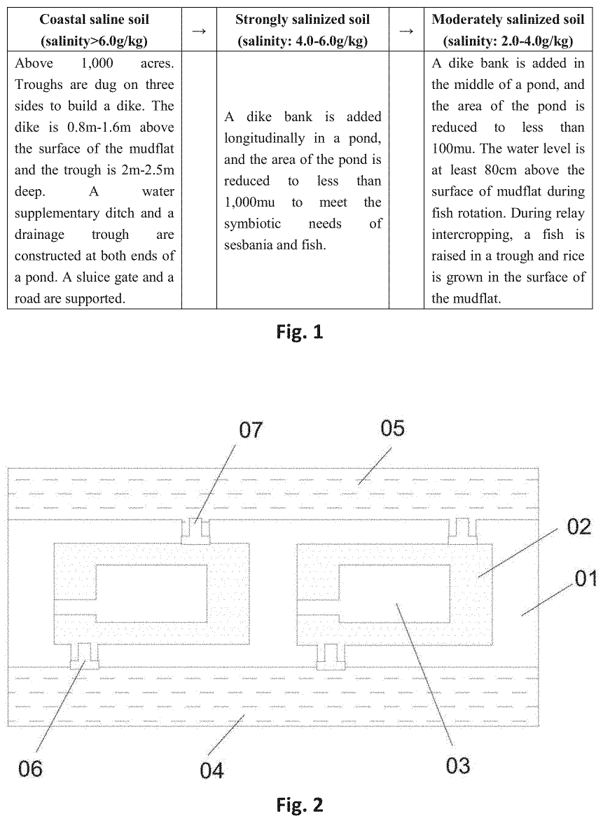

The specific test case of this embodiment is shown in FIG. 1, and the specific setting example is shown in FIG. 2. The meanings of reference signs are: a dike 01, a trench 02, the surface 03 of a mudflat, a water supplementary ditch 04, a drainage trough 05, a water supplementary sluice gate 06 and a drainage sluice gate 07.

In addition, for example, in this embodiment, aquaculture can be carried out in the following manner when the salinity of the soil of the target coastal mudflat is larger than 6.0 g/kg:

A silver and bighead carp mode, a prussian carp mode, a barracuda mode, a grass parabramis mode and a fish-shrimp mode are adopted respectively for aquaculture and the natural leaching of a desert beach is taken as a control. After 1 year of the aquaculture, the 0-80 cm desalination rate of the soil and the average increment of nutrients in 0-40 cm of a soil layer are measured and calculated.

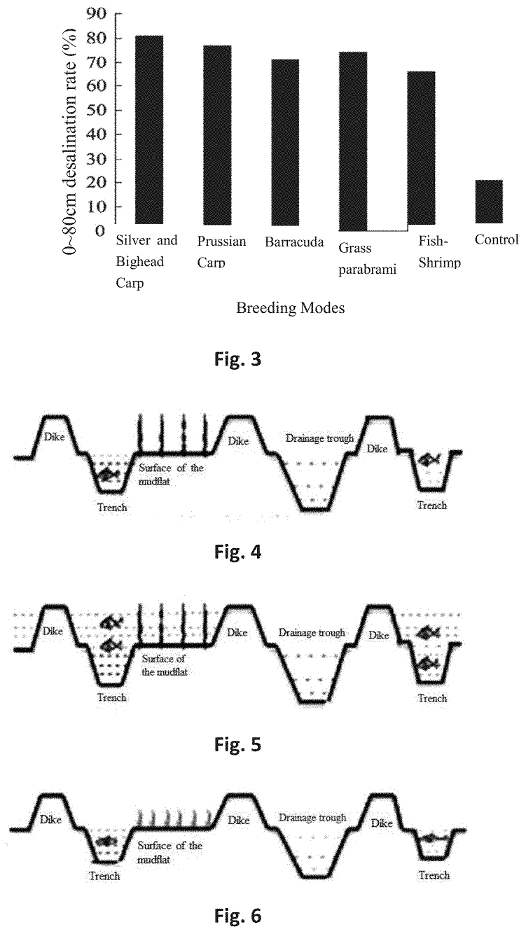

0-80 cm desalination rate of soil is shown in FIG. 3. The desalination rate of 0-80 cm of the soil of the silver and bighead carp mode, the prussian carp mode, the barracuda mode, the grass parabramis mode and the fish-shrimp mode is 3 to 4 times as much as that of the natural leaching of the desert beach, and the desalination cycle can be shortened by two thirds.

The average increment of the nutrients in 0-40 cm of the soil layer is shown in the following table:

| | | | Alkaline- | | Rapidly |
|---|---|---|---|---|---|
| | Organic | Total | deposited | Total | available |
| Breeding | matter | nitrogen | nitrogen | phosphorus | phosphorus |
| Mode | (g/kg) | (g/kg) | (mg/kg) | (g/kg) | (m/kg) |
| Silver And | 2.12 | 0.22 | 9.98 | 0.16 | 7.99 |
| Bighead | | | | | |
| Carp Mode | | | | | |
| Prussian | 1.73 | 0.17 | 7.14 | 0.12 | 6.25 |
| Carp Mode | | | | | |
| Barracuda | 1.32 | 0.15 | 6.21 | 0.08 | 5.49 |
| Mode | | | | | |
| Grass | 1.43 | 0.16 | 7.11 | 0.10 | 6.16 |
| Parabramis | | | | | |
| Mode | | | | | |
| Fish- | 1.04 | 0.11 | 4.90 | 0.05 | 4.16 |
| Shrimp | | | | | |
| Mode | | | | | |

The results show that the soil of the silver and bighead carp mode, the prussian carp mode, the barracuda mode, the grass parabramis mode and the fish-shrimp mode has the annual increase in organic matter of 1.04-2.12 g/kg, in total nitrogen of 0.11-0.22 g /kg, in total phosphorus of 0.05-0.16 g/kg, in alkali-decomposed nitrogen of 4.90-9.98 mg/kg and in rapidly available phosphorus of 4.16-7. 99 mg/kg.

If the silver and bighead carp mode, the prussian carp mode, the barracuda mode, the grass parabramis mode and the fish-shrimp mode are adopted, the feed residue and fish excrement in the system are used for soil fertilization. The system has high utilization efficiency in solar energy. The primary productivity carbon output of the system is more than 5 times as much as that of a desert beach system. The production of the fish is about 500 kg/mu, which is close to that of a conventional fish pond in conventional soil.

### Embodiment 2

This embodiment is a system for protecting the ecology of a coastal mudflat adopted in Embodiment 1, which is built by the following steps:

Plan and design a pond project according to the specific conditions of the target coastal mudflat to be protected; dig a trench and build a dike in the surface of the target coastal mudflat, and enclose the dike to form at least one pond, wherein the trench in the pond is adjacent to the surface of the mudflat. The depth of the trench is 2-2.5 m and the height of the dike is 0.8-1.6 m to form the pond with a large water surface, a shallow water layer and a seasonal open waterfront. The large water surface indicates that the water surface area of the single pond is at least 100 mu when the surface of the mudflat is stored with water. The shallow water layer indicates that the storage depth of water is at least 0.8 m and at most does not exceed the height of the dike when the surface of the mudflat is stored with water. The seasonal open waterfront indicates that the surface of the mudflat is kept free of water for a predetermined period of time to expose the surface of the mudflat. In addition, a drainage trough and a water supplementary ditch that are independent with each other are dug in the surface of the mudflat outside the pond. A water supplementary sluice gate and a drainage sluice gate are built in the dike so that the water supplementary ditch is connected to the pond via the water supplementary sluice gate, and the pond is connected to the drainage trough via the drainage sluice gate.

The pond has the following specific states:

Within a first preset period of time, the pond is drained so that there is no water storage in the surface of the mudflat and the water storage is kept in the trench. An aquatic seedling is put into the trench, and the dropping seedling state of the aquaculture is kept. The first preset period of time belongs to the period from October of the current year to May of the following year.

Within the second preset period of time, the pond is stored with water to fill the trench to full with water, and the surface of the mudflat is gradually stored with water. The highest water level at most flushes with the top of the dike. The floodplain state of the aquaculture continues to be kept. The second preset period of time belongs to the period from May to November in the same year.

Within a third preset period of time, the pond is drained so that there is no water storage in the surface of the mudflat and the water storage is kept in the trench. The harvesting conditions of the aquatic product is kept in the pond. The third preset period of time belongs to the period from October to December in the same year.

The dropping seedling state, the floodplain state, and the harvesting state of the aquatic product are successively connected and form a cycle;

When the emergent aquatic plant is planted in the surface of the mudflat, the pond also has the following specific states:

The sowing state of the emergent aquatic plant that is sowed in the surface of the mudflat, within a fourth preset period of time.

The crop harvesting state of the emergent aquatic plant that is reaped, within a fifth preset period of time.

The first preset period of time, the second preset period of time, and the third preset period of time are independent of each other and are not overlapped with each other. The fourth preset period of time and the fifth preset period of time are independent of each other and are not overlapped with each other. The fourth preset period of time and the fifth preset period of time are partially overlapped with or are not overlapped with the first preset period of time, the second preset period of time or the third preset period of time, respectively.

When the salinity of the soil of the target coastal mudflat is larger than 6.0 g/kg, the total area of the trench in the pond and the surface of the mudflat is larger than 1000 mu. The ratio of the area of the trench to the area of the surface of the mudflat is 1:0.1-100. There is only aquaculture in the pond, or the aquaculture is performed while the emergent aquatic plant is planted in the surface of the mudflat.

When the salinity of the soil of the target coastal mudflat is larger than 4.0 g/kg but equal to or less than 6.0 g/kg, a dike bank is built in the pond so that the total area of the trench in the pond and the surface of the mudflat is less than 1000 mu. The ratio of the area of the trench to the area of the surface of the mudflat is 1:0.1-100. The aquaculture is performed in the pond while the emergent aquatic plant is also planted in the surface of the mudflat.

When the salinity of the soil of the target coastal mudflat is larger than 2.0 g/kg but equal to or less than 4.0 g/kg, the dike bank is built in the pond so that the total area of the trench in the pond and the surface of the mudflat is less than 100 mu. The ratio of the area of the trench to the area of the surface of the mudflat is 1:0.1-100. The aquaculture is performed in the pond while the emergent aquatic plant is planted in the surface of the mudflat.

The specific setting example of this embodiment is shown in FIG. 2. The meanings of reference signs are: a dike 01, a trench 02, the surface 03 of a mudflat, a water supplementary ditch 04, a drainage trough 05, a water supplementary sluice gate 06 and a drainage sluice gate 07.

### Embodiment 3

This embodiment adopts a method for protecting the ecology of a coastal mudflat of Embodiment 1.

In Step 3, when the aquaculture is performed while the emergent aquatic plant is planted in the surface of the mudflat, a preset fish-agriculture mode is adopted. The fish-agriculture mode comprises planting and breeding combination modes of fish-rice rotation or relay intercropping, fish-grass rotation or relay intercropping, fish-wheat rotation or relay intercropping, fish-oilseed rape rotation or relay intercropping, fish-salt-tolerant plant rotation or relay intercropping.

In the planting and breeding combination mode of the fish-wheat rotation, the ratio of the area of the trench to the planting area of barley is 1:1-20. The first preset period of time is the period from October of the current year to May of the following year when wheat is harvested. The second preset period of time is the period from May of the following year when the wheat is harvested to October. The third preset period of time is the period from October in the following year to the next first preset period of time. The fourth preset period of time is October of the current year, and the fifth preset period of time is May of the following year;

The specific processes of the fish-wheat rotation are as follows: in October of the current year, the aquatic seedling is put into the trench while the barley is sown in the surface of the mudflat without tillage. The aquatic seedling is filter-feeding fish species and eating fish species that are composed of in a predetermined proportion, after which the aquatic product is cultivated and the barley grows at the same time. After May of the following year when the wheat is harvested, water is stored to flood the mudflat by more than 1 m. The aquatic product is harvested by drainage in October of the following year, and then the next round of fish-wheat rotation starts.

For example: the ratio of the area of the trench to the planting area of the barley is 1:10. 55 kg/mu of fry is placed in the trench that has diked for three weeks in October. The weight ratio of a barracuda, a black carp, a grass carp, a silver carp, and a bighead carp is 5:8:2:3:1. The barley is planted in a raised field of the surface of the mudflat without tillage. After the wheat is harvest in May of the following year, rainwater gradually floods the mudflat by more than 1 m. By the end of October, water is released for fishing and the barley is planted in the surface of the mudflat. The economic benefits can reach 300 kg/mu of fish and 300 kg/mu of the barley.

In the planting and breeding combination mode of the fish-rice relay intercropping, the ratio of the area of the trench to the planting area of rice is 1:0.1-10. The first preset period of time is the period from November of the previous year to May of the current year when the rice is transplanted or the period from the beginning of May of the current year to May of the current year when the rice is transplanted. The second preset period of time is the period from May of the current year when the rice is transplanted to the time when the rice is harvested. The third preset period of time is the period from the time when the rice is harvested in the current year to the next first preset period of time. The fourth preset period of time is May of the current year, and the fifth preset period of time is the period when the rice is ripe in the current year;

The specific processes of the fish-rice relay intercropping are as follows: in November of the previous year or May of the current year, an aquatic seedling is put into the trench and the aquatic product is raised. Afterwards, the rice is transplanted in the surface of the mudflat in May of the current year. Afterwards, water is stored to flood the mudflat. The rice is harvested when the rice is ripe in the current year. Afterwards, the pond is drained to harvest the aquatic product, and then the next round of the fish-rice relay intercropping starts.

For example: the ratio of the area of the trench to the planting area of the rice is 1:1. 60 kg/mu of the fry is placed into the pond, the weight ratio of the barracuda, an allogynogenetic crucian carp, a bream, the grass carp, the silver carp and the bighead carp is 4:10:5:2:2:1. The economic benefit can reach 350 kg/mu of the fish and 350 kg/mu of the rice. Water can be saved by 40%, and total nitrogen and total phosphorus can be reduced by 50% and 55%, respectively.

The salt-tolerant plant comprises sesbania. In the planting and breeding mode of fish-sesbania relay intercropping, the ratio of the area of the trench to the planting area of the barley is 1:1-20. The first preset period of time is the period from the October of the current year to March of the following year when the sesbania is transplanted. The second preset period of time is the period from May of the following year to the time when the sesbania is harvested. The third preset period of time is from the time when the sesbania is harvested to the next first preset period of time. The fourth preset period of time is March of the following year. The fifth preset period of time is the period when the sesbania is harvested in the following year;

The specific processes of fish-sesbania relay intercropping are as follows: in October of the current year, the aquatic seedling is put into the trench and the aquatic product is cultivated. The eating fish species (a common carp and a crucian carp) account for more than half of the aquatic seedling. In March of the following year, the sesbania is sparsely sown in all the surface of the mudflat except a channel is reserved for fish. From May of the following year, with the growth of the sesbania, rain gradually floods the mudflat until a storage depth of water is 1 m (about by the end of July). The sesbania is harvested when the sesbania is ripe. Afterwards, the aquatic product is harvested. Then the next round of the fish-sesbania relay intercropping starts. The economic benefit of the fish-sesbania relay intercropping can reach more than 200 kg/mu of fish and 100 kg/mu of seeds of the sesbania.

In addition, the salt-tolerant plant can also comprise Jerusalem artichoke, when using fish-Jerusalem artichoke relay intercropping, the ratio of the area of the trench to the planting area of the Jerusalem artichoke is 1:0.1-50. The tail water of the trench to irrigate the Jerusalem artichoke, after being purified, the Jerusalem artichoke is recycled to a culture pond. For example, the ratio of the area of the trench to the planting area of the Jerusalem artichoke is 1:5, 60 kg/mu of fry is put into the pond. The weight ratio of the barracuda, the allogynogenetic crucian carp, the bream, the grass carp, the silver carp and the bighead carp is 4:10: 5:2:2:1. 400 kg of fish can be breed. The soil with 0.5% salt produces about three tons of the fresh weight of a tuber of the Jerusalem artichoke per mu. 0.3% saline soil produces four tons of the fresh weight of the tuber of the Jerusalem artichoke per mu with sugar content of about 18%. The output of a dry substance is above 900 kg/mu. Water can be saved by 50%, and total nitrogen and total phosphorus can be reduced by 45% and 40%, respectively.

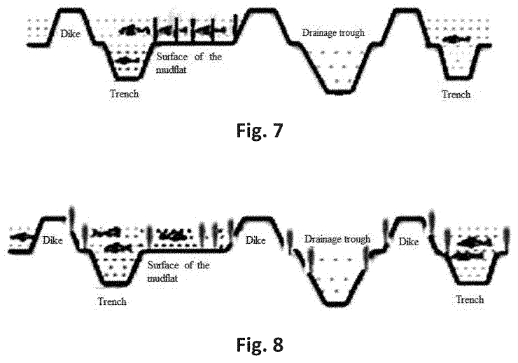

For example, in the specific implementation of this embodiment, for the strongly salinized soil, the fish-Jerusalem artichoke relay intercropping mode can be adopted. A water level is controlled in May, which is shown in FIG. 4. The water level is controlled from May to November, which is shown in FIG. 5. For the moderately salinized soil, the fish-wheat rotation and the fish-rice relay intercropping can be rotated. The fish-wheat rotation is adopted from October of the current year to May of the following year. The corresponding water level is controlled, which is shown in FIG. 6. The fish-rice relay intercropping is adopted from May of the following year to October of the following year, and the corresponding water level is controlled, which is shown in FIG. 7.

Experiments have confirmed that the energy output rate, the net economic benefit, and the value-added of the system storage energy of the fish-agriculture mode are 1.36, 1.35, and 1.71 times as much as those of the single breeding mode, respectively.

### Embodiment 4

This embodiment adopts a method for protecting the ecology of a coastal mudflat of Embodiment 1.

The aquatic product in the trench is the polyculture of a conventional fish and a barracuda, the polyculture of the conventional fish and an exopalaemon carinicauda, or the polyculture of the conventional fish and an acanthogobius hasta. The conventional fish comprises at least one of a black carp, a grass carp, a silver carp, a bighead carp, and an allogynogenetic crucian carp.

In this way, the above-mentioned polycultures can be used in aquaculture, which can make full use of the complementary niche of the coastal mudflat species such as the barracuda, the allogynogenetic crucian carp, the acanthogobius hasta, etc. and the conventional fish, extending a food chain, improving feed utilization, and increasing output and economic benefits.

For example, in the specific implementation of this embodiment, the coastal saline soil may only have the aquaculture, a diagram of which is shown in FIG. 8.

For example, in this embodiment, an ecological polyculture mode of 60% allogynogenetic crucian carp+30% barracuda+10% silver carp and bighead carp (3:1) can be adopted. An environmental load nitrogen (LN) and phosphorus (LP) are reduced by 21.89% and 19.65% compared with a silver crucian carp monoculture mode, respectively. the ecological polyculture mode can improve the utilization rate of nitrogen and phosphorus in the feed, reduce the feed coefficient by 16.0%, and increase the economic benefit by 32.51%.

### Embodiment 5

This embodiment adopts a method for protecting the ecology of a coastal mudflat of Embodiment 1.

The ratio of the area of the trench to the coverage area of an emerging aquatic plant is 1:0.1-100. The emerging aquatic plant comprises rice, wheat, barley, sesbania, Jerusalem artichoke, reed, calamus, cattail, iris wilsonii, scirpus, willow herb and rhizoma alismatis. In this way, this can not only play a better ecological protection function but also better guarantee the fishery production.

It should be noted that Embodiments 3 to 5 can be implemented in combination with each other according to actual conditions and feasibility.

### Embodiment 6

This adopts a method for protecting the ecology of a coastal mudflat of Embodiment 1 and a system for protecting the ecology of the coastal mudflat of Embodiment 2. when the salinity of the soil of the target coastal mudflat is larger than 6.0 g/kg (which is recorded as the first stage), the aquaculture polyculture of Embodiment 4 is adopted, and only aquaculture is adopted. when the salinity of the soil of the target coastal mudflat is larger than 4.0 g/kg but equal to or less than 6.0 g/kg (which is recorded as the second stage) and when the salinity of the soil of the target coastal mudflat is larger than 2.0 g/kg but equal to or less than 4.0 g/kg (which is recorded as the third stage), the appropriate fish-agriculture mode is adopted respectively, and the plant configuration of Embodiment 5 is adopted. When the salinity of the soil of the target coastal mudflat is less than 2.0 g/kg (that is, at the end of the third phase), the corresponding index values are measured or calculated.

Specifically, in the first stage, an adopted aquaculture polyculture mode is the silver carp, the bighead carp and the acanthogobius hasta. In the second stage, the aquaculture polyculture is adopted in the same way as the first stage. Meanwhile, the planting and breeding combination mode of the fish-sesbania relay intercropping of Embodiment 3 is adopted. In the third stage, the aquaculture polyculture is adopted in the same way as the first stage. Meanwhile, the planting and breeding combination mode of the fish-wheat rotation in Embodiment 3 is adopted. From the beginning of the first stage to the end of the third stage, the total time required by the ecosystem of the present invention is 3 to 5 years (3 years in this embodiment).

The original coastal mudflat and a general saline and alkaline land fish pond are used as a comparison. The original coastal mudflat is the coastal mudflat before the system for protecting the ecology of the coastal mudflat is built. The general saline and alkaline land fish pond is an area delineated only in the original coastal mudflat (the area and the system for protecting the ecology of the coastal mudflat are independent of each other and are not overlapped each other). The pond is built in accordance with the standard of the trench project of the above system. Cultivation is performed by adopting aquatic polyculture being the same as the first stage without the combination of planting and breeding. The time the area experiences is synchronized with the system for protecting the ecology of the coastal mudflat.

The index value of the original coastal mudflat is first measured, and then a comparative test starts. Afterwards, at the end of the third stage of the system for protecting the ecology of the coastal mudflat, the values of the corresponding indexes of the system for protecting the ecology of the coastal mudflat and the general saline and alkali land fish pond are measured or calculated. The indexes comprises primary productivity, plant diversity indexes, algae diversity, etc.

The results are shown in the following table:

| | | General | |
|---|---|---|---|
| | Original | saline and | |
| | coastal | alkali land | The system for protecting the |
| Indexes | mudflat | fish pond | ecologyof this embodiment |
| Primary | 1.5 | 2013.8 | 2842.5 |
| productivity | | | (being 1895 times as much as the |
| (MgC/ | | | original coastal mudflat, and being |
| m2 · d) | | | 1.4 times as much as the general |
| | | | saline and alkali land fish pond) |
| Plant | 0.2 | 0.56 | (being 6.3 times as much as the |
| diversity | | | original coastal mudflat, and being |
| (Shannon- | | | 2.4 times as much as the general |
| Wiener | | | saline and alkali land fish pond) |
| Index) | | | |
| Algae | 0.4 | 5.8 | (being 16.7 times as much as the |
| diversity | | | original coastal mudflat and being |
| (Shannon- | | | 1.2 times as much as the general |
| Wiener | | | saline and alkali land fish pond) |
| Index) | | | |

It can be seen that the index values of all aspects of this embodiment are significantly better than those of the original coastal mudflat and the general saline and alkali land fish pond.

In addition, the protective effect of this embodiment on a bird before and after implementation thereof is shown in the following table:

| | Before | After implementation |
|---|---|---|
| | implementation | (at the end of the third stage) |
| Bird species | 261 | 405 |
| | | There are national key protected |
| | | 12 species including a red-crowned |
| | | crane, a grey crane, a bald crane, |
| | | a white cranes, and 67 species in |
| | | type 2 protection. |
| Overwintering | 789 | 1000 |
| number of red- | | About 50% of the global wild |
| crowned cranes | | population |
| Overwintering | 1000 | 5000 |
| number of grey | | |
| cranes | | |

It can be seen that the implementation of this embodiment can play a very positive role in bird protection.

### Embodiment 7

The system for protecting the ecology of the coastal mudflat, the original coastal mudflat, the general saline and alkali land fish pond that are the same as those of Embodiment 6 are adopted. A general agricultural planting system is also used. The general agricultural planting system is an area delineated only in the original coastal mudflat (the area as well as the general saline and alkali land fish pond and the system for protecting the ecology of the coastal mudflat are independent of each other and are not overlapped each other). The same plant is simultaneously planted according to the mudflat planting of the above-mentioned system without the combination of planting and breeding. The time the area experiences is synchronized with the system for protecting the ecology of the coastal mudflat.

The index value of the original coastal mudflat is first measured, and then a comparative test starts. Afterwards, at the end of the third stage of the system for protecting the ecology of the coastal mudflat (three years in this embodiment), the values of the corresponding indexes of the system for protecting the ecology of the coastal mudflat, the general saline and alkali land fish pond and the general agricultural planting system are measured, and the indexes comprise the salinity of 0-80 cm of soil, organic matter, etc.

The results are shown in the following table:

| | | | | Alkaline- | | Rapidly |
|---|---|---|---|---|---|---|
| | | Organic | Total | decomposed | Total | available |
| | Salinity | matter | nitrogen | nitrogen | phosphorus | phosphorus |
| Ecosystem | (G/kg) | (G/kg) | (G/kg) | (Mg/kg) | (G/kg) | (Mg/kg) |
| Original | 6.77 | 0.54 | 0.07 | 0.33 | 0.03 | 1.51 |
| coastal | | | | | | |
| mudflat | | | | | | |
| General | 3.34 | 1.63 | 0.17 | 5.16 | 0.12 | 6.12 |
| saline and | | | | | | |
| alkali land | | | | | | |
| fish pond | | | | | | |
| General | 5.21 | 1.33 | 0.13 | 4.67 | 0.13 | 5.66 |
| agricultural | | | | | | |
| planting | | | | | | |
| system | | | | | | |
| The system | 1.51 | 2.11 | 0.22 | 12.18 | 0.16 | 8.87 |
| for | | | | | | |
| protecting | | | | | | |
| the ecology | | | | | | |
| of this | | | | | | |
| embodiment | | | | | | |

The results show that at the end of the system tor protecting the ecology of the coastal mudflat of the present embodiment, the salinity of soil decreases significantly, being only 22% of the original coastal mudflat, 45% of the general saline and alkali land fish pond, and 28.9% of the general agricultural planting system. The system for protecting the ecology of the coastal mudflat of this embodiment can effectively improve and fertilize the soil. The organic matter, total nitrogen, alkali-decomposed nitrogen, total phosphorus, and rapidly available phosphorus of the system for protecting the ecology of the coastal mudflat of this embodiment are 3.91, 3.14, 36.91 5.33, 5.87 times as much as those in the original coastal beach, respectively, are 1.29, 1.29, 2.36, 1.33, 1.45 times as much as those of the general saline and alkali land fish pond, and are 1.59, 1.69, 2.61, 1.23, 1.57 times as much as those of the general agricultural planting system.

It can be seen that the index values of all aspects of this embodiment are significantly better than the original coastal mudflat, the general saline and alkali land fish pond, and general agricultural planting system.

In addition to the above embodiments, the present invention may have other embodiments. All technical solutions formed by equivalent replacement or equivalent transformation fall within the scope of protection required by the present invention.

The Utility Model Claimed

1. A method for protecting the ecology of a coastal mudflat, comprising the following steps:
Step 1: plan and design a pond project according to the specific conditions of the target coastal mudflat to be protected;
Step 2: dig a trench and build a dike in the surface of the target coastal mudflat, and enclose the dike to form at least one pond, wherein the trench in the pond is adjacent to the surface of the mudflat, the depth of the trench is 2-2.5 m and the height of the dike is 0.8-1.6 m to form the pond with a large water surface, a shallow water layer and a seasonal open waterfront, the large water surface indicates that the water surface area of the single pond is at least 100 mu when the surface of the mudflat is stored with water, the shallow water layer indicates that the storage depth of water is at least 0.8 m and at most does not exceed the height of the dike when the surface of the mudflat is stored with water, the seasonal open waterfront indicates that the surface of the mudflat is kept free of water for a predetermined period of time to expose the surface of the mudflat; in addition, a drainage trough and a water supplementary ditch that are independent with each other are dug in the surface of the mudflat outside the pond, a water supplementary sluice gate and a drainage sluice gate are built in the dike so that the water supplementary ditch is connected to the pond via the water supplementary sluice gate, and the pond is connected to the drainage trough via the drainage sluice gate; when water is needed, the water supplementary sluice gate is opened and freshwater is filled into the pond via the water supplementary ditch; when drainage is needed, the drainage sluice gate is opened to drain out water via the drainage trough;
Step 3: cultivate an aquatic product in the trench, wherein the aquatic product is a fish or the fish and a shrimp, with or without an emergent aquatic plant planted in the surface of the mudflat; determine the storage progress of the water in the pond by combining the growth regularity of the emergent aquatic plant when the emergent aquatic plant is planted in the surface of the mudflat, and in accordance with the production rule of the aquatic plant cultivated in the trench so that the pond has the following specific states:
Within a first preset period of time, the pond is drained so that there is no water storage in the surface of the mudflat and the water storage is kept in the trench, an aquatic seedling is put into the trench and the dropping seedling state of the aquaculture is kept; the first preset period of time belongs to the period from October of the current year to May of the following year;
Within a second preset period of time, the pond is stored with water to fill the trench to full with water, and the surface of the mudflat is gradually stored with water, the highest water level at most flushes with the top of the dike, the floodplain state of the aquaculture continues to be kept; the second preset period of time belongs to the period from May to November in the same year;
Within a third preset period of time, the pond is drained so that there is no water storage in the surface of the mudflat and the water storage is kept in the trench, the harvesting conditions of the aquatic product is kept in the pond; the third preset period of time belongs to the period from October to December in the same year;
The dropping seedling state, the floodplain state, and the harvesting state of the aquatic product are successively connected and form a cycle;
When the emergent aquatic plant is planted in the surface of the mudflat, the pond also has the following specific states:
The sowing state of the emergent aquatic plant that is sowed in the surface of the mudflat, within a fourth preset period of time;
The crop harvesting state of the emergent aquatic plant that is reaped, within a fifth preset period of time;
Wherein the first preset period of time, the second preset period of time, and the third preset period of time are independent of each other and are not overlapped with each other; the fourth preset period of time and the fifth preset period of time are independent of each other and are not overlapped with each other; the fourth preset period of time and the fifth preset period of time are partially overlapped with or are not overlapped with the first preset period of time, the second preset period of time or the third preset period of time, respectively;
Step 4: in the process of performing Step 3, with the gradual decrease in the salinity of the soil of the coastal mudflat, adjust the structure of the pond according to the salinity of the soil of the coastal mudflat, and then continue to perform Step 3 to make the salinity of the soil of the coastal mudflat continue to fall.

2.The method for protecting the ecology of the coastal mudflat according to claim 1, wherein when planning and designing the pond project in Step 1 and adjusting the structure of the pond in Step 4, decision is made according to the salinity of the soil of the target coastal mudflat, the decision comprises:
When the salinity of the soil of the target coastal mudflat is larger than 6.0 g/kg, set the total area of the trench in the pond and the surface of the mudflat be larger than 1000 mu, set the ratio of the area of the trench to the area of the surface of the mudflat be 1:0.1-100, and set that there is only aquaculture in Step 3, or the aquaculture is performed while the emergent aquatic plant is planted in the surface of the mudflat;
When the salinity of the soil of the target coastal mudflat is larger than 4.0 g/kg but equal to or less than 6.0 g/kg, set the total area of the trench in the pond and the surface of the mudflat be less than 1000 mu by building a dike bank in the pond, set the ratio of the area of the trench to the area of the surface of the mudflat be 1:0.1-100, and set that in Step 3, aquaculture is performed while the emergent aquatic plant is also planted in the surface of the mudflat;
When the salinity of the soil of the target coastal mudflat is larger than 2.0 g/kg but equal to or less than 4.0 g/kg, set the total area of the trench in the pond and the surface of the mudflat be less than 100 mu by building the dike bank in the pond, set the ratio of the area of the trench to the area of the surface of the mudflat be 1:0.1-100, and set that in Step 3, the aquaculture is performed while the emergent aquatic plant is planted in the surface of the mudflat.

3. The method for protecting the ecology of the coastal mudflat according to claim 2, wherein when the salinity of the soil of the target coastal mudflat is larger than 6.0 g/kg, the soil of the coastal mudflat belongs to coastal saline soil; when the salinity of the soil of the target coastal mudflat is larger than 4.0 g/kg but equal to or less than 6.0 g/kg, the soil of the coastal mudflat belongs to strongly salinized soil; when the salinity of the soil of the target coastal mudflat is larger than 2.0 g/kg but equal to or less than 4.0 g/kg, the soil of the coastal mudflat belongs to moderately salinized soil.

4. The method for protecting the ecology of the coastal mudflat according to claim 1, wherein in Step 3, when the aquaculture is performed while the emergent aquatic plant is planted in the surface of the mudflat, a preset fish-agriculture mode is adopted, the fish-agriculture mode comprises planting and breeding combination modes of fish-rice rotation or relay intercropping, fish-grass rotation or relay intercropping, fish-wheat rotation or relay intercropping, fish-oilseed rape rotation or relay intercropping, fish-salt-tolerant plant rotation or relay intercropping.

5. The method for protecting the ecology of the coastal mudflat according to claim 4, wherein in the planting and breeding combination mode of the fish-wheat rotation, the ratio of the area of the trench to the planting area of barley is 1:1-20; the first preset period of time is the period from October of the current year to May of the following year when wheat is harvested, the second preset period of time is the period from May of the following year when the wheat is harvested to October, the third preset period of time is the period from October in the following year to the next first preset period of time; the fourth preset period of time is October of the current year, and the fifth preset period of time is May of the following year;
The specific processes of the fish-wheat rotation are as follows: in October of the current year, the aquatic seedling is put into the trench while the barley is sown in the surface of the mudflat without tillage, the aquatic seedling is filter-feeding fish species and eating fish species that are composed of in a predetermined proportion, after which the aquatic product is cultivated and the barley grows at the same time; after May of the following year when the wheat is harvested, water is stored to flood the mudflat by more than 1 m; the aquatic product is harvested by drainage in October of the following year, and then the next round of fish-wheat rotation starts;
In the planting and breeding combination mode of the fish-rice relay intercropping, the ratio of the area of the trench to the planting area of rice is 1:0.1-10; the first preset period of time is the period from November of the previous year to May of the current year when the rice is transplanted or the period from the beginning of May of the current year to May of the current year when the rice is transplanted, the second preset period of time is the period from May of the current year when the rice is transplanted to the time when the rice is harvested, the third preset period of time is the period from the time when the rice is harvested in the current year to the next first preset period of time; the fourth preset period of time is May of the current year, and the fifth preset period of time is the period when the rice is ripe in the current year;
The specific processes of the fish-rice relay intercropping are as follows: in November of the previous year or in May of the current year, the aquatic seedling is put into the trench and the aquatic product is cultivated; afterwards, the rice is transplanted in the surface of the mudflat in May of current year; afterwards, water is stored to flood the mudflat; the rice is harvested when the rice is ripe in the current year; afterwards, the pond is drained to harvest the aquatic product; then the next round of fish-rice relay intercropping starts;
The salt-tolerant plant comprises sesbania, in the planting and breeding combination mode of fish-sesbania relay intercropping, the ratio of the area of the trench to the planting area of the barley is 1:1-20; the first preset period of time is the period from October of the current year to March of the following year when the sesbania is planted, the second preset period of time is the period from May of the following year to the time when the sesbania is harvested, the third preset period of time is the period from the time when the sesbania is harvested in the following year to the next first preset period of time; the fourth preset period of time is March of the following year, and the fifth preset period of time is the period when the sesbania is ripe in the following year;
The specific processes of the fish-sesbania relay intercropping are as follows: in October of the current year, the aquatic seedling is put into the trench and the aquatic product is cultivated, the eating fish species accounts for more than half of the aquatic seedling; the sesbania is sown in March of the following year; water is stored to flood the mudflat in May of the following year until the depth of water is 1 m; the sesbania is harvested when the sesbania is ripe; then the pond is drained to harvest the aquatic product; afterwards, the next round of fish-sesbania relay intercropping starts.

6. The method for protecting the ecology of the coastal mudflat according to claim 1, wherein in Step 3, the aquatic product in the trench is the polyculture of a conventional fish and a barracuda, the polyculture of the conventional fish and an exopalaemon carinicauda, or the polyculture of the conventional fish and an acanthogobius hasta; the conventional fish comprises at least one of a black carp, a grass carp, a silver carp, a bighead carp, and an allogynogenetic crucian carp.

7. The method for protecting the ecology of the coastal mudflat according to claim 1, wherein the ratio of the area of the trench to the area covered by the emergent aquatic plant is 1:0.1-100; the emergent aquatic plant comprises the rice, the wheat, the barley, the sesbania, Jerusalem artichoke, reed, calamus, cattail, iris wilsonii, scirpus, willow herb and rhizoma alismatis.

8. A system for protecting the ecology of a coastal mudflat, which is built by the following steps:
Plan and design a pond project according to the specific conditions of the target coastal mudflat to be protected; dig a trench and build a dike in the surface of the target coastal mudflat, and enclose the dike to form at least one pond, wherein the trench in the pond is adjacent to the surface of the mudflat, the depth of the trench is 2-2.5 m and the height of the dike is 0.8-1.6 m to form the pond with a large water surface, a shallow water layer and a seasonal open waterfront, the large water surface indicates that the water surface area of the single pond is at least 100 mu when the surface of the mudflat is stored with water, the shallow water layer indicates that the storage depth of water is at least 0.8 m and at most does not exceed the height of the dike when the surface of the mudflat is stored with water, the seasonal open waterfront indicates that the surface of the mudflat is kept free of water for a predetermined period of time to expose the surface of the mudflat; in addition, a drainage trough and a water supplementary ditch that are independent with each other are dug in the surface of the mudflat outside the pond, a water supplementary sluice gate and a drainage sluice gate are built in the dike so that the water supplementary ditch is connected to the pond via the water supplementary sluice gate, and the pond is connected to the drainage trough via the drainage sluice gate.

9. The system for protecting the ecology of the coastal mudflat according to claim 8,
wherein the pond has the following specific states:
Within a first preset period of time, the pond is drained so that there is no water storage in the surface of the mudflat and the water storage is kept in the trench, an aquatic seedling is put into the trench and the dropping seedling state of the aquaculture is kept; the first preset period of time belongs to the period from October of the current year to May of the following year;
Within a second preset period of time, the pond is stored with water to fill the trench to full with water, and the surface of the mudflat is gradually stored with water, the highest water level at most flushes with the top of the dike, the floodplain state of the aquaculture continues to be kept; the second preset period of time belongs to the period from May to November in the same year;
Within a third preset period of time, the pond is drained so that there is no water storage in the surface of the mudflat and the water storage is kept in the trench, the harvesting conditions of the aquatic product is kept in the pond; the third preset period of time belongs to the period from October to December in the same year;
The dropping seedling state, the floodplain state, and the harvesting state of the aquatic product are successively connected and form a cycle;
When the emergent aquatic plant is planted in the surface of the mudflat, the pond also has the following specific states:
The sowing state of the emergent aquatic plant that is sowed in the surface of the mudflat, within a fourth preset period of time;
The crop harvesting state of the emergent aquatic plant that is reaped, within a fifth preset period of time;
Wherein the first preset period of time, the second preset period of time, and the third preset period of time are independent of each other and are not overlapped with each other; the fourth preset period of time and the fifth preset period of time are independent of each other and are not overlapped with each other; the fourth preset period of time and the fifth preset period of time are partially overlapped with or are not overlapped with the first preset period of time, the second preset period of time or the third preset period of time, respectively.

10. The system for protecting the ecology of the coastal mudflat according to claim 9, wherein when the salinity of the soil of the target coastal mudflat is larger than 6.0 g/kg, the total area of the trench in the pond and the surface of the mudflat is larger than 1000 mu, the ratio of the area of the trench to the area of the surface of the mudflat is 1:0.1-100, and there is only aquaculture in the pond, or the aquaculture is performed while the emergent aquatic plant is planted in the surface of the mudflat;
When the salinity of the soil of the target coastal mudflat is larger than 4.0 g/kg but equal to or less than 6.0 g/kg, a dike bank is built in the pond so that the total area of the trench in the pond and the surface of the mudflat is less than 1000 mu, the ratio of the area of the trench to the area of the surface of the mudflat is 1:0.1-100, the aquaculture is performed in the pond while the emergent aquatic plant is also planted in the surface of the mudflat;
When the salinity of the soil of the target coastal mudflat is larger than 2.0 g/kg but equal to or less than 4.0 g/kg, the dike bank is built in the pond so that the total area of the trench in the pond and the surface of the mudflat is less than 100 mu, the ratio of the area of the trench to the area of the surface of the mudflat is 1:0.1-100, and the aquaculture is performed in the pond while the emergent aquatic plant is planted in the surface of the mudflat.
